(19) United States
(12) Patent Application Publication
(10) Pub. No.: US 2017/0193420 A1
(43) Pub. Date: Jul. 6, 2017

(54) SYSTEM AND METHOD FOR ENHANCED GAMIFIED PERFORMANCE MANAGEMENT AND LEARNING SYSTEM

(71) Applicant: Shailesh Tiwari, Hyderabad (IN)

(72) Inventor: SHAILESH TIWARI, Hyderabad (TG)

(21) Appl. No.: 15/396,260

(22) Filed: Dec. 30, 2016

(30) Foreign Application Priority Data
Dec. 30, 2015 (IN) 7070/CHE/2015

(51) Int. Cl. G06Q 10/06; G06Q 50/00

(52) U.S. Cl. CPC G06Q 10/06398; G06Q 10/06393; G06Q 50/01

(57) ABSTRACT

The embodiments herein provide a system and method for improving employee performance and engagement at the workplace. The embodiments herein employ gamification and predictive analytics to improve employee performance and engagement at the workplace. The system includes an action tracking module, a gamified performance management module, and a gamified learning module. The system provides a metric to measure employee engagement (measured through activity and impact points) and reward the employees accordingly. The system enables overall transparency and monitoring of input and output metrics. Further, the system brings together peer feedback, senior management feedback, advanced analytics, learning and knowledge levels and self-management practices (such as personalized goal-setting) onto a common platform, thus serving to be a comprehensive new age performance management system.

### CROSS-REFERENCE TO RELATED APPLICATION

Benefit is claimed under 35 U.S.C. 119(a)-(d) to Foreign application Serial No. 7070/CHE/2015 filed in India entitled “SYSTEM AND METHOD FOR ENHANCED GAMIFIED PERFORMANCE MANAGEMENT AND LEARNING SYSTEM”, on Dec. 30, 2015, which is herein incorporated in its entirety by reference for all purposes.

### BACKGROUND

Technical Field

The embodiments herein are generally related to a method and system to enable organizations manage employee performance management and engagement more effectively than current conventional practices. The embodiments herein are particularly related to a digital performance management system (PMS) for managing employee performance, employee engagement and capability building in an organization. The embodiments herein are more particularly related to a gamified performance management and learning system, referred collectively as a gamified performance management system or a gamified PMS, to improve the method of enhancing employee performance, motivation and employee engagement in organizations.

Description of the Related Art

Over many decades, companies are constantly trying to improve performance management techniques for driving workforce productivity and performance of employees as measured through the lens of key performance indicators (KPIs), generally defined at a monthly quarterly or an animal level. Companies adopt various strategies to improve employee productivity and engagement through various practices such as target setting (i.e., defining targets, making targets transparent, clear and measurable for each employee), continuous monitoring of employee performance against targets, linking payout to performance, offering incentives and bonus based on performance, conducting, periodic performance dialogues at the workplace etc., thereby attempting to influence focus areas and performance of employees. Companies have been investing in management information systems, automation for performance monitoring, and offering monetary rewards such as incentives and year-end bonuses based on employees' achievements against KPIs.

However, recent surveys conducted globally suggest that a large proportion of executives opine that the performance and employee engagement levels are not significantly impacted or improved by the current performance management strategies and practices. The executives believe that such strategies have limited impact in the continual and sustainable improvement of employee productivity and employee engagement. Employee engagement surveys conducted by the likes of Gallup indicate that globally, a relatively small portion of employees, approximately 13%, are actively engaged at the workplace.

In order to address the issues of employee performance and engagement mentioned above, companies have recently started adopting gamification techniques as an innovative and game-based approach to managing performance and driving engagement by stimulating motivation levels, especially by influencing intrinsic motivators which, by definition, are not linked to external or monetary rewards. Such gamification techniques are also enabling employees towards self-management, which is a practice where each employee manages his/her own performance by carefully tracking his performance metrics digitally and developing a self-improvement plan. Through gamification, the workplace engagement levels are stimulated using a series of tools and techniques typically found in video or digital games. For instance, to drive performance, employee-level competitiveness is harnessed in a positive manner and captured through leaderboards to drive a greater sense of competition/goal-orientation in the workplace and thus generating an increase in overall productivity. The rules of the ‘game’ provide employees with a clear understanding of goals, metrics, timelines and behaviors that lead to attaining higher performance levels and achieving rewards and recognitions in such gamified systems. At the core such gamified systems have a constant tracking of achievement i.e., score-keeping e.g., via a game ‘currency’ such as “points”. Achievements are broadcasted on private and public scoreboards, thereby providing near real-time feedback and score-keeping for the employees.

Currently in most performance management systems and approaches, a method of managing employee performance is largely “output” oriented i.e., based on “outputs” or “results” achieved by the employee. The method does not typically factor “inputs” or the day-to-day activities and efforts of employees that drive or lead to results. Further, the method includes managers assigning/mandating individual goals (employee performance targets) which are typically aligned with the short-term and/or long-term goals of the organization. In other words, targets are set top-down and employees typically have limited flexibility in setting their own goals; in particular at lower rungs within organizations, employees have limited say in the definition and/or quantum of these goals targets. Furthermore, suggestions for improving the performance are made by the direct line manager of the employee in a rather direct mariner as opposed to through a consultative manner. Performance dialogues between direct line manager and employee tend to be ad-hoc and vary from team to team within an organization. In other words, the management practices around performance dialogues and performance discussions are unstructured and vary from line manager to line manager.

Hence, there is a need for a more effective performance management system that transforms the way performance is managed at the workplace by re-orienting and motivating the workforce on both input factors as well as results/output factors to achieve the goals set by the organization in an optimal and sustainable manner. Such a transformational system would also enable an employee-led personal goal setting approach i.e., allowing for employees to set personalized goals and self-development plans that are influenced and informed by the overall goals and targets of the organization and or their division thus setting an environment of “self-management”. Organizations under such systems can still define the overall enterprise-level targets and objectives in a top-down manner. However, if employees are empowered to define and develop their own “game-plans” (i.e., path to reaching the goals through an individualized goal setting approach), such a system, by its very nature, creates greater ownership towards goals.

The above-mentioned shortcomings, disadvantages and problems are addressed herein and which will be understood by reading and studying the following specification.

### OBJECTS OF THE EMBODIMENTS

The primary object of the embodiments herein is to provide a system and method to enhance performance management in organizations (especially at the “frontline” i.e., at the lower rungs in the organization by incorporating a gamified self-management technique supported by gamification techniques and a novel concept of ‘game-plan’, a feature that allows employees to break down targets (set by the organization) into smaller goals/sub-goals that the employees define (e.g., monthly targets can be broken down into weekly sub-goals). Using game-plan, employees can set personalized goals that are built around the targets defined by the line manager and/or senior management. These personalized goals can very well be over and above the targets defined by the management For example, an employee can set his personalized goal to become a top-3 employee in his division. As such, these personalize goals are not meant to be a replacement of the targets that that the management may have set for the employee; instead these personalized goals are meant to capture an employee's personal aspiration and is guided by the targets defined by the management.

Yet another objective of the embodiments herein is to provide game-plan simulation feature that enables an employee to set individualized goals, follow through on these goals, compare these goals and achievement towards these goals against benchmarks internal benchmarks of the organization), run scenarios to understand and visualize what levels of outputs are needed to achieve specific objectives such as attaining certain rank in the organization leaderboard, winning a specific badge and/or becoming a top performer.

Yet another objective of the embodiments herein is to provide a game-plan simulation feature that enables am employee to understand the average levels of inputs required to attain a certain output, such as, understanding the number of client calls required to close a sale. Number of client calls represents an input measure while closing a deal or a sale represents an output.

Another objective of the embodiments herein is to provide a system and method to track and make transparent activity levels of employees in an organization, to understand and correlate the input activities performed by employees and outputs achieved, in order to enable mechanisms for orienting and motivating employees on input factors, activities over and above outputs or results.

Yet another objective of the embodiments herein is to provide a system and method to enable an approach to define and award two types of points to an employee; one for the activities performed (“activity points”) and the other for outputs achieved (“impact points”), thereby enabling mechanisms for motivating employees and stimulating behaviors around not just the results, but also around the input factors or activities.

Yet another objective of the embodiments herein is to provide a system and method to award points to employees and activities on a near real-time basis such as hourly or daily basis to create a greater level of transparency, competition, and engagement at the workplace.

Yet another objective of the embodiments herein is to incorporate social metrics such as ‘like’ and ‘follow’, that serves as a mechanism for incorporating subjective feedback from peers as well as superiors, to offer additional data points and social inputs for performance evaluation and driving motivation of employees. In addition to serving as a metric of performance (e.g., as a measure of collaboration), social metrics are added to serve as a catalyst in boosting motivation levels of an employee.

Yet another objective of the embodiments herein is to provide recommendations to employees based on their past performance records of accomplishment and through such recommendations guide employees to define their own goals, priorities and areas of focus. In other words, recommendations serve as nudges or triggers for employees to set their own goals, “game-plans” or priorities.

Yet another objective of the embodiments herein is to conduct seasonal campaigns to enhance the productivity of the employees during such periods.

Yet another objective of the embodiments herein is to provide a system and method to “challenge” employees falling short of achieving their goals, by offering short-term incentives and challenges that are initiated by one or more employees to one or more colleagues.

These and other objects and advantages of the embodiments herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the most detailed description that is presented later.

The other objects and advantages of the embodiments herein will become readily apparent from the following description taken in conjunction with the accompanying drawings.

The various embodiments herein provide a system for improving employee performance and engagement at a workplace. The system comprises of an action tracking module, a performance management module, and a learning games module.

The action tracking module is configured to track a plurality of activities in relation to outputs. The activities that can be tracked in the system are customizable. For illustration, activities include input activities such as employee attendance, amount of time spent at the workplace, customer calls made or received by an employee, customer meetings conducted by the employee, number of core processes initiated or completed by the employee (processes for which the employee is responsible for); the action tracking module is communicably coupled with a performance management module. The action tracking module also links with results i.e., outputs. The key purpose of the action tracking module is to orient the focus of the organization towards activities (that lead to results) instead of focusing on results alone.

The performance management module is configured to improve employee performance in an enterprise by leveraging techniques of gamification. The performance management module includes a point module, a rank and badge module, a communication module, a planning module, a recommendation module, a campaign builder module, a challenge module, a redemption module, and an analytics module.

The points module is configured to convert input activities to “activity points”, and output achieved to “impact points”. Points are assigned to users based on the user's activity determined by the action tracking module. The points module uses a customizable logic for conversion of activity to activity points, and output achieved by the employee to impact points. The points are awarded to an employee in near real-time basis.

The rank and badge module is configured to award the plurality of ranks (across a number of variables i.e., various activity types and output types), badges (awards), levels performance level of an employee based on quantitative, configurable metrics) and leaderboard mentions (social metrics i.e., “likes”, “comments” or “follow”) to the employees. The rank and badge module uses the points provided by the points module for determining ranks and badges. The rank and badge module is communicably coupled to the points module.

The communication module is configured to enable communication between a plurality of hierarchy levels, and the communication module enables employees to communicate via a digital medium.

The planning module is configured to enable an employee to set and follow personalized goals (“game-plan”) and simulate the game-plan to understand level of activities required to achieve the personalized goals. The personalized goals are guided by targets set by the enterprise but equally importantly, the personalized goal or game-plan represents the employee's own “output aspirations”. The planning module enables an employee to simulate his/her game-plan around various output aspirations or objectives (e.g., earning a certain quantum of incentives, winning a badge, say the top employee badge). Additionally, the planning module enables line managers to provide feedback in a digital manner on the game-plans set by their direct repartee and the planning module allows line managers to simulate and cascade/allocate their personal plans to their direct reportees (in other words, a line manager gets to simulate the levels of output that need to be achieved by his direct reportees in order for the line manager to achieve his personalized goal. The simulation also makes transparent the level of inputs required by each employee in order for the line manager to achieve his personalized goal or game-plan).

The recommendation module is configured to provide suggestions to the plurality of employees on a plurality of dimensions. The recommendation module uses predictive analytics and rules set by the enterprise to provide recommendations, and the recommendation module is communicably coupled to the planning module. Recommendations are designed to drive employees into action and aspire for higher levels of performance. An employee can act upon a recommendation by setting his/her personalized goals through the planning module.

The campaign builder module is configured to allow the employees for creation and miming of seasonal campaigns; the seasonal campaigns motivate employees to aim and achieve higher productivity compared to that during a regular period. The campaign module is communicably coupled to the communication module.

The challenge module is configured to challenge an employee o achieve or exceed a desired output set by a challenger, and wherein the challenge module is configured to identify a super performer, an over performer, an average performer, and an underperformer based on analytics and a set of rules, and wherein the challenge module is communicably coupled to the communication module. Challenge is primarily focused towards the average performers and under performers. The challenger (typically a system administrator/direct line manager) throws a “challenge” to the target employee. Such target employees are identified based on analytics. The challenge is communicated digitally and serves to stimulate the employee to clear the challenge and thus achieve higher performance. The challenge module is complimentary to the campaign module in the sense that the campaign module targets a large audience or set of employees and in contrast, the challenge module specifically targets the average/under performers with specific and time bound goals/challenges to meet.

The redemption module is configured to enable the employees to redeem their activity points and the impact points, and the redemption module allows the employees to redeem the activity and impact points for a tangible and/or intangible reward.

The analytics module is configured to provide a quantitative view of the performance of the plurality of employees, and the analytics module generates a comprehensive performance dashboard covering performance against a plurality of parameters. The analytics module uses predictive analytics to generate insights and reports, and the analytics module is communicably coupled to the planning module.

The learning games module is configured to organize learning modules as a plurality of games. The games module imparts knowledge and skills to the plurality of employees for performing tasks in the enterprise. The games module is communicably coupled with a performance management module.

According to an embodiment herein, the action tracking module tracks the input activities performed by the employees of the enterprise including but not limited to submitting a client call report, creating and/or updating a sales lead, completing a learning module, referring a sales lead to another employee, following-up on business leads, submitting a business idea, completing internal project milestones, daily attendance, time spent at work or on a particular work systems (e.g., a dialer to call prospective clients). The action tracking module tracks and feeds the activity related information to the performance management module.

According to an embodiment herein, the action tracking module tracks the outputs achieved by the employees of the enterprise against the KPIs set for the employees by the management. Such achievements could include (but are not limited to) the closure of a sale, completion of a process/project, launch of a product, achieving revenue/profit/cost targets etc. The action tracking module tracks the outputs and feeds the progress to the performance management module.

According to an embodiment herein, the planning module enables are employee to set and follow personalized goals (“game-plan”) and simulate the game-plan to understand level of activities required to achieve the personalized goals. The personalized goal or game-plan is guided by targets set by the enterprise; yet it is distinct from the targets in the sense that a personalized goal represents the employee's own “output aspiration”. The planning module enables an employee to simulate his/her game-plan around various of output aspirations or objectives (e.g., earning a certain quantum of incentives, winning a badge, say the top employee badge). Additionally, the planning module enables line managers to provide feedback in a digital manner on the game-plans set by their direct reportees and the planning module allows line managers to simulate and cascade/allocate their personal plans to their direct reportees (in other words, a line manager gets to simulate the levels of output that need to be achieved by his direct reportees in order for the line manager to achieve his personalized goal. The simulation also makes transparent the level of inputs required by each employee in order for the line manager to achieve his personalized goal or game-plan).

The recommendation module generates recommendations based on the past performance track record of the employee and the employee's current performance trajectory. The recommendation module interacts with the analytics module and presents tailored recommendations to the employee i.e., recommendations which are tailor-made for the employee based on advanced analytics and that if followed by the employee are designed to improve his/her performance. Recommendations use a variety of analytics such as movement (increase or decrease) in ranks, activity level comparisons, proximity to winning a badge based on points i.e., a badge that the employee can earn through marginal increment in points, or possibility of earning greater incentives. The primary logic behind recommendations is to identify and present as recommendations “nearby” success milestones that an employee can reach by making an incremental stretch in activity levels and outputs. Such incremental stretches when repeated multiple times translate into a sustained increase in employee productivity. Recommendations drive an employee to action by serving as a trigger for the employee to set his/her personalized goals. An employee can act upon a recommendation by setting his/her personalized goals through the planning module.

According to an embodiment herein, the parameters used in the analytics module include Key Performance Indicators (KPIs), activity levels, knowledge levels, skill levels, SWOT (strength, weakness, opportunity or threat) and trend and correlation analyses.

According to an embodiment herein, the database is configured to store data and metadata about the action tracking module, performance management module, and learning games module.

The various embodiments herein provide a computer implemented method for improving employee performance and engagement at a workplace. The method includes tracking a plurality of activities performed and results achieved by a plurality of employees, managing and improving the performance of the plurality of employees of an enterprise, and designing and offering digital learning games to enable employee learning.

The activities performed by a plurality of employees are tracked through an action tracking module, and the plurality of activities include input activities such as submitting a client call report, creating and/or updating a sales lead, completing a learning module, referring a sales lead to another employee, following-up on business leads, submitting a business idea, completing internal project milestones, daily attendance, time spent at work or on a particular work systems (e.g., a dialer to call prospective clients). The action tracking module also tracks the outputs achieved by a plurality of employees.

According to an embodiment herein, managing the performance of the plurality of employees include, converting input activities to activity points and outputs achieved to impact points, recognizing the plurality of employees (i.e., through awarding points, ranks, badges, status, levels etc.) communicating between a plurality of employee hierarchy levels, offering a planning function i.e., creating a game-plan for the plurality of employees, making system-triggered recommendations for the plurality of employees, creating a plurality of campaigns to allow the plurality of employees to create and run seasonal campaigns, challenging a plurality of employees to achieve the desired output set by a challenger of the enterprise, redeeming the plurality of points awarded to the plurality of employees, analyzing the performance of the plurality of employees and building the skill and knowledge base of the plurality of employees through learning games.

According to an embodiment herein, activity points are calculated based on the employee activity determined by tracking the activities, and the points are awarded based on a customizable logic for conversion of input activity to activity points. Similarly impact points are calculated based on the employee outputs determined by tracking the outputs achieved by the employee. According to an embodiment herein, the activity points are awarded to an employee in near real-time. Impact points are awarded to an employee as and when the system receives the data feed of outputs achieved by the employee (this can be near real time or in some cases be awarded on a daily basis if output data feed takes a longer time to consolidate/validate in the organization). As activity points are awarded on a near real-time basis they create high-frequency engagements loop (since the employee gets to see instantly the conversion of his/her actions into points) as well as competition loop among the employee and his/her peers. The engagement loop is made stronger by utilizing points for the calculations of rank, badges, SWOT, performance flags etc. Additional triggers come in the form of recommendations, challenges or campaigns which stimulate an employee to aim for higher points and perform greater level of activities. The activity points thus motivate the employee to do perform more activities/take more actions compared to a business as usual scenario (where there is little motivation for an employee to do more activities). Assuming constant skill level, more activities translate to more output. Thus, activity points, by motivating an employee to perform more activities lead the employee to achieve more outputs thereby increasing overall productivity,

According to an embodiment herein, awarding the plurality of employees include providing a plurality of ranks, badges, redemption awards, levels, and leaderboard mentions, and such awarding of the plurality of employees is based on their points.

According to an embodiment herein, the communication is established via a digital medium.

According to an embodiment herein, planning a game-plan allows each employee to create and follow a personalized goal, understand the level of activities that are needed to achieve the desired personalized goal. The personalized goals are aligned to the targets set by the enterprise, yet they are distinct from the targets in the sense that these personalized goals represent the achievement aspiration of the employee.

According to an embodiment herein, recommendations are provided based on predictive analytics and rules set by the enterprise. Recommendations are intended to drive an employee to action and set personalized goals in line with the recommendations through the planning module.

According to an embodiment herein, the admin user can create and run seasonal campaigns through the campaign module, and die seasonal campaign motivates employees to aim and achieve higher productivity compared to a regular period.

According to an embodiment herein, challenges are driven by analytics and are targeted towards average performers and under-performers; specifically, challenges stimulate the average performers and under performers to achieve higher performance through the pursuit of the challenge. The challenger (typically a system administrator/direct line manager) throws a “challenge” to the target employee. Such target employees are identified based on analytics. The challenge is communicated digitally and serves to stimulate the employee to clear the challenge and thus achieve higher performance. The challenge module is complimentary to the campaign module in the sense that the campaign module targets a large audience or set of employees and in contrast, the challenge module specifically targets the average/under performers with specific and time bound goals/challenges to meet.

According to an embodiment herein, the employee has the option to redeem the plurality of points for tangible and intangible rewards.

According to an embodiment herein, employee-level analyses are generated based on analyzing comprehensive performance based on a plurality of parameters, and the analyses are based on predictive analytics that generate insights and reports.

According to an embodiment herein, the learning games are delivered to impart knowledge and skills to the plurality of employees for performing tasks in the enterprise, and the games feed into the performance management module. Through the scores achieved by employees while playing these learning games, the system recognizes the know ledge levels of employees which can then be correlated to their performance levels. This provides for a positive loop aimed to improve performance by improving skills and knowledge of employees.

According to an embodiment herein, the input activities tracked for awarding activity points to the employees include (but are not limited to) submitting a client call report, creating sales lead, following-up on business leads, meeting a customer, submitting a business proposal, submitting a business idea, completing internal project milestones and completing a learning module. Additionally, input activities could include input factors such as employee attendance, referrals made by the employee to other employees, amount of time spent by the employee at the workplace, number of core processes initiated by the employee or completed by the employee (processes for which the employee is responsible for).

According to an embodiment herein, the outputs and results achieved by employees are tracked for awarding impact points towards achievements against the KPIs set for the employees by the management. Such achievements include (but are not limited to) the closure of a sale, completion of a process, launch of a product, achieving revenue/profit/cost targets etc.

According to an embodiment herein, planning a game-plan allows each employee to create and follow a personalized goal, understand the level of activities that are needed to achieve the desired personalized goal. The personalized goals are aligned to the targets set by the enterprise, yet they are distinct from the targets in the sense that these personalized goals represent the achievement aspiration of the employee.

According to an embodiment herein, the recommendations are generated based on predictive analytics and rules set by the enterprise. Recommendations are intended to drive an employee to action. An employee can act upon a recommendation by setting his, personalized goals through the planning module.

According to an embodiment herein, the parameters used for analyses include Key Performance Indicators (KPIs), activity levels, knowledge/skill levels, and performance trends and correlations.

According to an embodiment herein, the method further includes storing data and metadata about the activities tracked, management of performance, and designing and offering digital learning games.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which:

FIG.1 illustrates a system architecture or a block diagram of a system for an enhanced gamified performance management system (PMS), according to an embodiment herein.

FIG. 2 illustrates a flowchart explaining a method of enhancing the employee engagement, according to e embodiment herein.

FIG. 3A illustrates a screenshot of a game-plan of an employee, according to an embodiment herein.

FIG. 3B illustrates a screenshot of simulation of the game-plan, according to an embodiment herein.

FIG. 4A illustrates a screenshot, of quick-view or a dashboard screen with base representation of activities, impact, badges, flags, SWOT etc. of an application, according to an embodiment herein.

FIG. 4B illustrates a screenshot of the second, page of the application depicting leaderboard for competition, according to an embodiment herein,

FIG. 4C illustrates a screenshot of the third page of the application depicting badges for interim success, according to an embodiment herein.

FIG. 4D illustrates a screenshot of the fourth page of the application depicting news and internal communication, according to once embodiment herein.

Although the specific features of the embodiments herein are shown in sonic drawings and not in others. This is done for convenience only as each feature may be combined with any or all of the other features in accordance with the embodiment herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system for improving employee performance and engagement at a workplace. The system comprises of an action tracking module, a performance management module, and a learning games module.

The action tracking module is configured to track a plurality of activities in relation to outputs. The activities that can be tracked in the system are customizable. For illustration, activities include input activities such as employee attendance, amount of time spent at the workplace, customer calls made or received by an employee, customer meetings conducted by the employee, number of core processes initiated or completed by the employee (processes for which the employee is responsible for); the action tracking module is communicably coupled with a performance management module. The action tracking module also links with results i.e., outputs. The key purpose of the action tracking module is to orient the focus of the organization towards activities (that lead to results) instead of focusing on results alone.

The performance management module is configured to improve employee performance in an enterprise by leveraging techniques of gamification. The performance management module includes a point module, a rank and badge module, a communication module, a planning module, a recommendation module, a campaign builder module, a challenge module, a redemption module, and an analytics module.

The points module is configured to convert input activities to “activity points”, and output achieved to “impact points”. Points are assigned to users based on the user's activity determined by the action tracking module. The points module uses a customizable logic for conversion of activity to activity points, and output achieved by the employee to impact points. The points are awarded to an employee in near real-time basis.

The rank and badge module is configured to award the plurality of ranks (across a number of variables i.e., various activity types and output types), badges (awards), levels performance level of an employee based on quantitative, configurable metrics) and leaderboard mentions (social metrics i.e., “likes”, “comments” or “follow”) to the employees. The rank and badge module uses the points provided by the points module for determining ranks and badges. The rank and badge module is communicably coupled to the points module.

The communication module is configured to enable communication between a plurality of hierarchy levels, and the communication module enables employees to communicate via a digital medium.

The planning module is configured to enable an employee to set and follow personalized goals (“game-plan”) and simulate the game-plan to understand level of activities required to achieve the personalized goals. The personalized goals are guided by targets set by the enterprise but equally importantly, the personalized goal or game-plan represents the employee's own “output aspirations”. The planning module enables an employee to simulate his/her game-plan around various output aspirations or objectives (e.g., earning a certain quantum of incentives, winning a badge, say the top employee badge). Additionally, the planning module enables line managers to provide feedback in a digital manner on the game-plans set by their direct reportees and the planning module allows line managers to simulate and cascade/allocate their personal plans to their direct reportees (in other words, a line manager gets to simulate the levels of output that need to be achieved by his direct reportees in order for the line manager to achieve his personalized goal. The simulation also makes transparent the level of inputs required by each employee in order for the line manager to achieve his personalized goal or game-plan).

The recommendation module is configured to provide suggestions to the plurality of employees on a plurality of dimensions. The recommendation module uses predictive analytics and rules set by the enterprise to provide recommendations, and the recommendation module is communicably coupled to the planning module. Recommendations are designed to drive employees into action and aspire for higher levels of performance. An employee can act upon a recommendation by setting his/her personalized goals through the planning module.

The campaign builder module is configured to allow the employees for creation and running of seasonal campaigns; the seasonal campaigns motivate employees to aim and achieve higher productivity compared to that during a regular period. The campaign module is communicably coupled to the communication module.

The challenge module is configured to challenge an employee o achieve or exceed a desired output set by a challenger, and wherein the challenge module is configured to identify a super performer, an over performer, an average performer, and an underperformer based on analytics and a set of rules, and wherein the challenge module is communicably coupled to the communication module. Challenge is primarily focused towards the average performers and under performers. The challenger (typically a system administrator/direct line manager) throws a “challenge” to the target employee. Such target employees are identified based on analytics. The challenge is communicated digitally and serves to stimulate the employee to clear the challenge and thus achieve higher performance. The challenge module is complimentary to the campaign module in the sense that the campaign module targets a large audience or set of employees and in contrast, the challenge module specifically targets the average/under performers with specific and time bound goals/challenges to meet.

The redemption module is configured to enable the employees to redeem their activity points and the impact points, and the redemption module allows the employees to redeem the activity and impact points for a tangible and/or intangible reward.

The analytics module is configured to provide a quantitative view of the performance of the plurality of employees, and the analytics module generates a comprehensive performance dashboard covering performance against a plurality of parameters. The analytics module uses predictive analytics to generate insights and reports, and the analytics module is communicably coupled to the planning module.

The learning games module is configured to organize learning modules as a plurality of games. The games module imparts knowledge and skills to the plurality of employees for performing tasks in the enterprise. The games module is communicably coupled with a performance management module.

According to an embodiment herein, the action tracking module tracks the input activities performed by the employees of the enterprise including but not limited to submitting a client call report, creating and/or updating a sales lead, completing a learning module, referring a sales lead to another employee, following-up on business leads, submitting a business idea, completing internal project milestones, daily attendance, time spent at work or on a particular work systems (e.g., a dialer to call prospective clients). The action tracking module tracks and feeds the activity related information to the performance management module.

According to an embodiment herein, the action tracking module tracks the outputs achieved by the employees of the enterprise against the KPIs set for the employees by the management. Such achievements could include (but are not limited to) the closure of a sale, completion of a process/project, launch of a product, achieving revenue/profit/cost targets etc. The action tracking module tracks the outputs and feeds the progress to the performance management module.

According to an embodiment herein, the planning module enables are employee to set and follow personalized goals (“game-plan”) and simulate the game-plan to understand level of activities required to achieve the personalized goals. The personalized goal or game-plan is guided by targets set by the enterprise; yet it is distinct from the targets in the sense that a personalized goal represents the employee's own “output aspiration”. The planning module enables an employee to simulate his/her game-plan around various of output aspirations or objectives (e.g., earning a certain quantum of incentives, winning a badge, say the top employee badge). Additionally, the planning module enables line managers to provide feedback in a digital manner on the game-plans set by their direct reportees and the planning module allows line managers to simulate and cascade/allocate their personal plans to their direct reportees (in other words, a line manager gets to simulate the levels of output that need to be achieved by his direct reportees in order for the line manager to achieve his personalized goal. The simulation also makes transparent the level of inputs required by each employee in order for the line manager to achieve his personalized goal or game-plan).

The recommendation module generates recommendations based on the past performance track record of the employee and the employee's current performance trajectory. The recommendation module interacts with the analytics module and presents tailored recommendations to the employee i.e., recommendations which are tailor-made for the employee based on advanced analytics and that if followed by the employee are designed to improve his/her performance. Recommendations use a variety of analytics such as movement (increase or decrease) in ranks, activity level comparisons, proximity to winning a badge based on points i.e., a badge that the employee can earn through marginal increment in points, or possibility of earning greater incentives. The primary logic behind recommendations is to identify and present as recommendations “nearby” success milestones that an employee can reach by making an incremental stretch in activity levels and outputs. Such incremental stretches when repeated multiple times translate into a sustained increase in employee productivity. Recommendations drive an employee to action by serving as a trigger for the employee to set his/her personalized goals. An employee can act upon a recommendation by setting his/her personalized goals through the planning module.

According to an embodiment herein, the parameters used in the analytics module include Key Performance Indicators (KPIs), activity levels, knowledge levels, skill levels, SWOT (strength, weakness, opportunity or threat) and trend and correlation analyses.

According to an embodiment herein, the database is configured to store data and metadata about the action tracking module, performance management module, and learning games module.

The various embodiments herein provide a computer implemented method for improving employee performance and engagement at a workplace. The method includes tracking a plurality of activities performed and results achieved by a plurality of employees, managing and improving the performance of the plurality of employees of an enterprise, and designing and offering digital learning games to enable employee learning.

The activities performed by a plurality of employees are tracked through an action tracking module, and the plurality of activities include input activities such as submitting a client call report, creating and/or updating a sales lead, completing a learning module, referring a sales lead to another employee, following-up on business leads, submitting a business idea, completing internal project milestones, daily attendance, time spent at work or on a particular work systems (e.g., a dialer to call prospective clients). The action tracking module also tracks the outputs achieved by a plurality of employees.

According to an embodiment herein, managing the performance of the plurality of employees include, converting input activities to activity points and outputs achieved to impact points, recognizing the plurality of employees (i.e., through awarding points, ranks, badges, status, levels etc.) communicating between a plurality of employee hierarchy levels, offering a planning function i.e., creating a game-plan for the plurality of employees, making system-triggered recommendations for the plurality of employees, creating a plurality of campaigns to allow the plurality of employees to create and run seasonal campaigns, challenging a plurality of employees to achieve the desired output set by a challenger of the enterprise, redeeming the plurality of points awarded to the plurality of employees, analyzing the performance of the plurality of employees and building the skill and knowledge base of the plurality of employees through learning games.

According to an embodiment herein, activity points are calculated based on the employee activity determined by tracking the activities, and the points are awarded based on a customizable logic for conversion of input activity to activity points. Similarly impact points are calculated based on the employee outputs determined by tracking the outputs achieved by the employee. According to an embodiment herein, the activity points are awarded to an employee in near real-time. Impact points are awarded to an employee as and when the system receives the data feed of outputs achieved by the employee (this can be near real time or in some cases be awarded on a daily basis if output data feed takes a longer time to consolidate/validate in the organization). As activity points are awarded on a near real-time basis they create high-frequency engagements loop (since the employee gets to see instantly the conversion of his/her actions into points) as well as competition loop among the employee and his/her peers. The engagement loop is made stronger by utilizing points for the calculations of rank, badges, SWOT, performance flags etc. Additional triggers come in the form of recommendations, challenges or campaigns which stimulate an employee to aim for higher points and perform greater level of activities. The activity points thus motivate the employee to do perform more activities/take more actions compared to a business as usual scenario (where there is little motivation for an employee to do more activities). Assuming constant skill level, more activities translate to more output. Thus, activity points, by motivating an employee to perform more activities lead the employee to achieve more outputs thereby increasing overall productivity.

According to an embodiment herein, awarding the plurality of employees include providing a plurality of ranks, badges, redemption awards, levels, and leaderboard mentions, and such awarding of the plurality of employees is based on their points.

According to an embodiment herein, the communication is established via a digital medium.

According to an embodiment herein, planning a game-plan allows each employee to create and follow a personalized goal, understand the level of activities that are needed to achieve the desired personalized goal. The personalized goals are aligned to the targets set by the enterprise, yet they are distinct from the targets in the sense that these personalized goals represent the achievement aspiration of the employee.

According to an embodiment herein, recommendations are provided based on predictive analytics and rules set by the enterprise. Recommendations are intended to drive an employee to action and set personalized goals in line with the recommendations through the planning module.

According to an embodiment herein, the admin user can create and run seasonal campaigns through the campaign module, and the seasonal campaign motivates employees to aim and achieve higher productivity compared to a regular period.

According to an embodiment herein, challenges are driven by analytics and are targeted towards average performers and under-performers; specifically, challenges stimulate the average performers and under performers to achieve higher performance through the pursuit of the challenge. The challenger (typically a system administrator/direct line manager) throws a “challenge” to the target employee. Such target employees are identified based on analytics. The challenge is communicated digitally and serves to stimulate the employee to clear the challenge and thus achieve higher performance. The challenge module is complimentary to the campaign module in the sense that the campaign module targets a large audience or set of employees and in contrast, the challenge module specifically targets the average/under performers with specific and time bound goals/challenges to meet.

According to an embodiment herein, the employee has the option to redeem the plurality of points for tangible and intangible rewards.

According to an embodiment herein, employee-level analyses are generated based on analyzing comprehensive performance based on a plurality of parameters, and the analyses are based on predictive analytics that generate insights and reports.

According to an embodiment herein, the learning games are delivered to impart knowledge and skills to the plurality of employees for performing tasks in the enterprise, and the games feed into the performance management module. Through the scores achieved by employees while playing these learning games, the system recognizes the knowledge levels of employees which can then be correlated to their performance levels. This provides for a positive loop aimed to improve performance by improving skills and knowledge of employees.

According to an embodiment herein, the input activities tracked for awarding activity points to the employees include (but are not limited to) submitting a client call report, creating sales lead, following-up on business leads, meeting a customer, submitting a business proposal, submitting a business idea, completing internal project milestones and completing a learning module. Additionally, input activities could include input factors such as, employee attendance, referrals made by the employee to other employees, amount of time spent by the employee at the workplace, number of core processes initiated by the employee or completed by the employee (processes for which the employee is responsible for).

According to an embodiment herein, the outputs and results achieved by employees are tracked for awarding impact points towards achievements against the KPIs set for the employees by the management. Such achievements include (but are not limited to) the closure of a sale, completion of a process, launch of a product, achieving revenue/profit/cost targets etc.

According to an embodiment herein, planning a game-plan allows each employee to create and follow a personalized goal, understand the level of activities that are needed to achieve the desired personalized goal. The personalized goals are aligned to the targets set by the enterprise, yet they are distinct from the targets in the sense that these personalized goals represent the achievement aspiration of the employee.

According to an embodiment herein, the recommendations are generated based on predictive analytics and rules set by the enterprise. Recommendations are intended to drive an employee to action. An employee can act upon a recommendation by setting his, personalized goals through the planning module.

According to an embodiment herein, the parameters used for analyses include Key Performance Indicators (KPIs), activity levels, knowledge/skill levels, and performance trends and correlations.

According to an embodiment herein, the method further includes storing data and metadata about the activities tracked, management of performance, and designing and offering digital learning games.

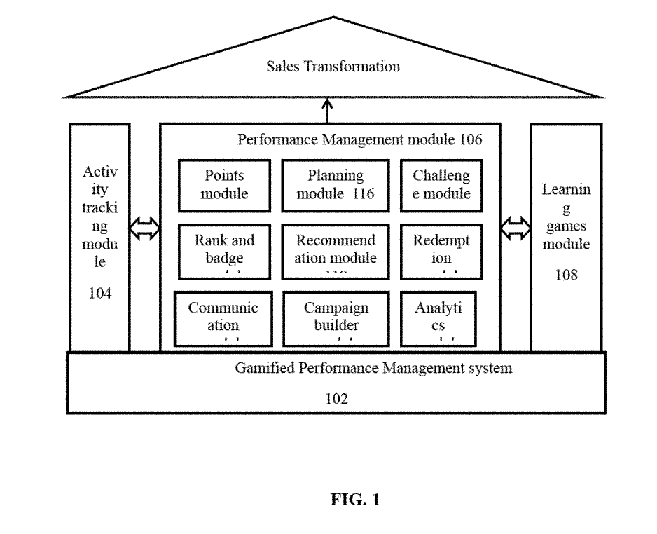

FIG.1 illustrates the architecture of an enhanced gamified performance management system (PMS). The architecture of enhanced gamified PMS is built on a foundation of gamified performance management system 102. The enhanced PMS comprises an action tracking module 104, a performance management module 106 and a learning games module 108.

According to one embodiment herein, the action tracking module 104 tracks the input activities performed by the employee and outputs achieved by the employee. The input activities of the employee include submitting a client call report, creating sales lead, following-up on business leads, meeting a customer, submitting a business proposal, submitting a business idea, completing internal project milestones and completing a learning module. Additionally, input activities could include input factors such as employee attendance, referrals made by the employee to other employees, amount of time spent by the employee at the workplace, number of core processes initiated by the employee or completed by the employee (processes for which the employee is responsible for). The output achieved by the employee includes but is not limited to achievement against a KPI, closure of a sale, completion of a process/project, launch of a product, achieving revenue/profit/cost targets etc. The action tracking module 104 feeds the activities and impact data of the employee as the employee performs various business activities and gains impact (business results/outputs).

According to one embodiment herein, the performance management module, 106 enhances the method of managing performance in an organization. The module is designed for improving employee performance and employee engagement at the workplace leading to increased employee productivity. The module makes use of gamification techniques and predictive analytics to drive performance management and employee engagement. The performance of the employee is tracked, analyzed and managed in a game-like manner to motivate the employee to achieve higher levels of achievement. The performance management module 106 comprises a points module 110, a rank and badge module 112, a communication module 114, a planning module 116, a recommendation module 118, a campaign builder module 120, a challenge module 122, a redemption module 124 and an analytics module 126.

According to one embodiment herein, the points module 110 receives the activity data of the employee (as the employee performs business activities) and impact data of by the employee measured through results/output achieved by the employee. The points module 110 uses customizable logic and measurements for converting the activity data to activity points and impact data to impact points. The points module 110 awards the employee activity points for each input activity tracked and captured by the action tracking module 104. The activity points are awarded on a near real-time basis, thereby creating a high-frequency engagement loop (as the employee gets to see instantly the conversion of their actions into points) as well as competition loop among the employee and his peers (as the points impact ranking of an employee instantly). The engagement loop is made stronger by utilizing points for the calculations of rank, badges, SWOT, performance flags etc. Additional triggers come in the former of recommendations, challenges or campaigns which stimulate an employee to aim for higher points and perform greater level of activities. The activity points thus motivate the employee to perform more activities/take more actions compared to a business as usual scenario (where there is little motivation for an employee to focus on activities). Assuming constant skill level, more activities translate to more output. Thus, activity points, by motivating an employee to perform more activities, lead the employee to achieve more outputs thereby increasing employee productivity. The points module 110 also awards the employee impact points for each achieved output as reported by the organization. Impact points are awarded to an employee as and when the system receives the input feed of outputs achieved by the employee (this can be near real time or in some cases be awarded on a daily basis if outputs take a longer time to consolidate/validate in the organization). The activity points and impact points, when taken together, are used for translating the overall employee performance into a single currency i.e., overall points, which are particularly helpful in comparing employees from different teams/divisions within the organization who may not necessarily have same targets/tasks to perform. Overall points, thus bring all employees under one umbrella of comparison. Further, the activity points and impact points help the employee to visibly understand the relation between input activities (effort) and outputs achieved (result) and thereby driving home a simple message that employee productivity can be improved by increasing the input levels and the input conversion factor to output—a message that lays at the core of this efficient gamified performance management system.

According to one embodiment herein, the points module 110 feeds the activity points and impact points to the rank and badge module 112. The rank and badge module 112 awards the employee ranks against the employee's peers, evaluates employee performance for earning potential badges, determines the level of the employee in the game and crafts multiple leaderboards for the employee against the employee's peers, on the basis of points accumulated by the employee. The rank module publishes leaderboards on multiple dimensions such as overall points (composite of activity points and impact points), impact points, activity points, individual activity-wise leaderboards, KPI-wise leaderboard, leaderboard based on count of badges, leaderboard based on conversion ratio between input and output points etc.

According to one embodiment herein, the communication module 114 drives employee engagement in the enhanced gamified PMS, system. The communication module 114 provides an intra-company social communication platform for the senior and mid-level managers, line managers and peers to broadcast recognition, publish suggestions/appreciations (a virtual “pat on the back”) and public praise for any employee. The social metrics in the application includes actions such as ‘like’ and ‘follow’. Managers and the peers choose to ‘like’ or ‘follow’ the employee on the basis of the employee's performance. The social metrics serve to motivate the employee through social recognition and public praise thereby driving engagement. The social metrics are publicized using the communication module 114, thereby boosting the productivity levels of the employee. Additionally, the communication module is used by Managers to provide virtual one-on-one feedback on performance of their reportees and have a virtual group conversation with a wider set of reportees/peers.

According to one embodiment herein, the planning module 116 generates a game-plan for each employee. The module allows each employee to create and follow-through his/her own personalized goal (“game-plan”). The employee sets personalized goals aligned to the targets set by the organization. The personalized goal or game-plan is guided by targets set by the enterprise; yet it is distinct from the targets in the sense that a personalized goal represents the employee's own “output aspiration”. An employee can run simulations on his/her game-plan. The simulation of game-plan allows the employee to understand and visualize levels of input required to attain the desired output aspiration. The levels of input required are understood by varying the levels of the desired output during simulation of game-plan. An employee sets his/her game-plan by entering a desired level of output he aspires to achieve in a specified timeframe. Based on the desired output, the planning module converts and brings to the attention of the employee the required levels of input needed to achieve the desired output aspiration/goal. For example, a goal can be the level of output an employee aims to achieve in a month or in a week. Game-plan simulation also enables the employee to understand the interplay of different KPIs in achieving different personalized objectives. The personalized objectives that an employee can set for himself/herself include one or more of attaining a rank, earning monthly incentive, attaining a status badge etc. In an exemplary embodiment, the employee chooses to earn monthly incentive as the personalized goal. The simulation of game-plan provides the employee information regarding the level of output across multiple KPIs to be achieved for qualifying for the monthly incentive or earning a desired level of monthly incentive pay. The feature of simulation sheds transparency on the levels of output to be achieved to qualify for a desired personalized objective. By giving the power in the hands of an employee to set his own personalized plan, the game-plan facilitates self-management, goal setting and goal tracking as well as provides feedback to the employee against self-defined goals. Additionally, the planning module enables line managers to provide feedback in a digital manner on the game-plans set by their direct reportees and the planning module allows line managers to simulate and cascade/allocate their personal plans to their direct reportees (in other words, a line manager gets to simulate the levels of output that need to be achieved by his direct reportees in order for the manager to achieve his personalized goal. The simulation also makes transparent the level of inputs required by each employee in order for the line manager to achieve his personalized goal or game-plan).

According to one embodiment herein, the recommendation module 118 provides suggestions to the employee on various dimensions such as achieving a game-plan or for achieving a badge which the employee is very close to winning or for avoiding a performance flag (which an employee can get if he/she falls in the bottom layer of performance among peers) or for closing a business lead which, as per predictive analytics, is highly likely to close. The recommendation module 118 uses predictive analytics and rule-based modules to provide recommendations to the employee. The recommendation module 118 generates recommendations based on the past performance track record of the employee as well as the recent most performance trajectory (e.g., daily trend of performance in the current month). The primary logic behind recommendations is to identity and present as recommendations “nearby” success milestones that an employee can reach by making an incremental stretch in activity levels and outputs. Such incremental stretches when repeated multiple times translate into a sustained increase in employee productivity. Recommendations drive an employee to action by serving as a trigger for the employee to set his/her personalized goals. An employee can act upon a recommendation by setting his/her personalized goals through the planning module. For line managers, recommendation module 118 also generates suggestions on employees that are set to over-perform or underperform and those who are unlikely to meet their goals. Through these recommendations on employees, line managers have the ability to act and focus on selective employees to drive their performance. By providing focus to line managers, recommendations serve as a powerful intervention/tool that line managers can utilize to drive overall performance and productivity of their teams.

According to one embodiment herein, the campaign builder module 120 provides a platform to design and conduct seasonal campaigns. Campaigns are built on contests which in turn are defined as clear, time bound competitions around various activity parameters (e.g., number of business leads created, number of sales calls, number of business proposals etc.) or output parameters (e.g., number of products sold, value of products sold etc.). The employee also is enabled to set “winning a campaign”, as one of the desired results as part of employee's game-plan. A separate points module awards the employee with impact points for achievements under the seasonal campaign. Further, rank and badge module 112 also award special campaign ranks for the seasonal campaigns to the employee.

According to one embodiment herein, the challenge module 122 provides a platform where the employee can be challenged to achieve a certain level of output or perform a certain level of activities within a defined timeframe. The challenge module 122 monitors the employees falling short of achieving the target set by the organization. The challenger can be another employee (peer), or the direct line manager or a central admin officer. For the benefit of line managers and/or a central admin officer, the challenge module which is driven by analytics identifies average or underperforming employees i.e., employees requiring special attention employees falling short of achieving certain KPIs). After identifying employees requiring performance focus, line managers/central admin officer have the ability to throw a specific, time-bound challenge to such employees. Completing the challenge within the specified time range allows the employee to who the challenge was thrown earn extra impact and activity points. A challenge thrown the line manager for example serves dual purpose—one it informs the employee that he/she is under line managers' performance focus. Second, the challenge creates a short-term opportunity for the employee to earn extra points (booster points). As another use case, an employee may want to engage another peer who is performing better than the employee into a challenge. This creates a short-term performance duel thus driving performance of both employee and the peer. Thus, either originating through a line manager or another peer, challenges motivates employees towards a performance boost by bringing the power of focus and sense of competition.

According to one, embodiment herein, the redemption module 124 enables the employee to redeem the activity points and impact points. The employee earns tangible or intangible benefits on redemption of the activity points and impact points. In an exemplary embodiment, the activity points and impact points get converted to currency based on conversion ratios set by the enterprise and thus, upon redemption provide tangible/intangible rewards that drive employee motivation, productivity and engagement.

According to one embodiment herein, the analytics module 126 runs a number of analyses around employees' activities, results, correlations between activity and results, performance trends, movement in ranking etc. At a macro level, analytics module converts the platform into a self-management tool for an employee by providing all the analytics, performance metrics to an employee on his fingertips. This is quite distinct from MIS since MIS (management information system) typically serves the requirements of Management but does not address the information needs of a frontline employee. As information about performance lies on the fingertips of each employee, every employee is stimulated to act. This is akin to a player in a game having his and his team score readily available to him to act upon. The analytics module 126 generates a performance dashboard providing transparency and insights around the day to day activities, results, ranking, badges, SWOT (strengths, weaknesses, opportunity and threats) of the employee. Further, the analytics module 126 makes use of advanced and predictive analytics to forecast the performance of employees, generate insights on the correlation between the employee activities and results, identify signs/trends of performance deterioration of employees thus serving as an early warning indicator. The report identifies the correlation between employee's input activity and impact i output achieved which is used by management to identify clusters of employees where productivity can be improved by increasing activity levels and activity conversion ratios (i.e., ratio of activity to results). Further, the report identifies a correlation between the employee's skills (measured through points in learning games module) and impact, thereby identifying clusters of employees where productivity can be improved by increasing skill levels.

According to one embodiment herein, the learning games module 108 organizes learning modules as games. The learning modules 108 impart knowledge and skills to the employee for performing various tasks in the organization. On completing each learning module, the points module 110 awards points (i.e. activity points for learning) to the employee. The awarding of points motivates the employee to learn and advance in his/her learning trajectory.

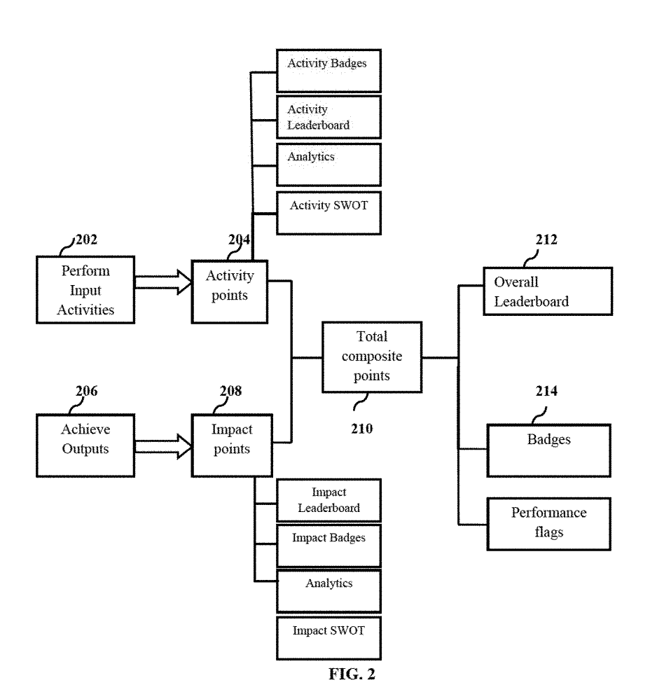

FIG. 2 illustrates a flow chart explaining a method of enhancing the employee engagement. The employee performs the various input activities for achieving desired output (202). The action tracking module tracks the input activities performed by the user and resulting outputs. The input activities are performed in order to achieve, the personalized goals set by the employees or targets set by the organization and/or to win challenges campaigns designed in the system. The input activities of the employee include but are not limited to submitting a client call report, creating sales lead, following-up on business leads, meeting a customer, submitting a business proposal, submitting a business idea, completing internal project milestones and completing a learning module. Additionally, input activities could include input factors such as employee attendance, referrals made by the employee to other employees, amount of time spent by the employee at the workplace, number of core processes initiated by the employee or completed by the employee (processes for which the employee is responsible for). The action tracking module translates the activities into activity points in the application. Similarly, the outputs achieved by employees are converted into impact points. The outputs achieved by the employee include but are not limited to achievement against a KPI, the closure of a sale, completion of a process/project, launch of a product, achieving revenue/profit/cost targets etc. Both impact points and activity points form the basis for running all key analytics, ranks, badge calculation, SWOT etc. For example, based on the activity points earned by the employee activity rank, activity related badges, activity SWOT and activity conversion ratios are calculated. System provides several triggers to motivate the employee to increase activity levels. Recommendations, campaigns, challenges are mechanisms built on top of ranks, badges, SWOT that stimulate an employee towards action. Impact points are awarded to an employee as and when the system receives the input feed of outputs achieved by the employee (this can be near real time or in some cases be awarded on a daily basis if outputs take a longer time to consolidate/validate in the organization). The activity points and impact points, when taken together, are used for translating the overall employee performance into a single currency i.e., overall points, which are particularly helpful in comparing employees from different teams/divisions within the organization who may not necessarily have same targets tasks to perform. Overall points, thus bring all employees under one umbrella of comparison. Further, the activity points and impact points help the employee to visibly understand the relation between input activities (effort) and outputs achieved (result) and thereby driving home a simple message that employee productivity can be improved by increasing the input levels and the input conversion factor to output—a message that lays at the core of this efficient gamified performance management system.

The points module translates employee's input activities into activity points based on the conversion metric defined by the organization (204). The activity points are awarded almost near real-time, thereby creating a greater level of engagement and competition as explained in [00134]. The activity points are awarded for the employee actions/activities and hence motivate every employee to focus on performing more activities/take more actions, thereby enhancing the overall employee productivity of the organization.

Further, the application also tracks the outputs achieved by the employee. The activity tracking engine tracks the outputs achieved by the employee (206). The outputs achieved by the employee include but is not limited to achievement against a KPI, the closure of a sale, completion of a process/project, launch of a product, achieving revenue/profit/cost targets etc. The application converts the achievements of the employee into impact points. Further, the impact points are fed to the performance management module.

The points module converts the activities into activity points and outputs achieved to impact points (208) and is available to be analyzed at all levels and at every level of granularity, thereby creating transparency in evaluating the employee performance and the corresponding outputs generated.

Further, the method adds the activity points and impact points to find the total composite points earned by the employee (210). The employee redeems the total composite points or impact or activity points to various tangible and intangible benefits. The tangible and intangible rewards drive employee motivation and more broadly the employee productivity and engagement.

Further, the method broadcasts the names of the employees on the leaderboard in the decreasing order of the total composite points earned by the employee (212). The leaderboard is a scoreboard showing the names and current points of the leading employees in the organization. Leaderboard ignites competitiveness among employees by showcasing the performance of the top performers. The method includes multiple leaderboards for overall points, impact points, and activity points and for individual KPIs and activities, in order to allow the comparison of employee's performance across multiple dimensions.

Furthermore, the method includes awarding badges and ranks for the employees (214). The rank and badge module 112 awards the employees with different ranks and badges based on the total composite points earned by the employee. Badges are also awarded separately on activity points as well as impact points. The method includes providing the employees with different badges based on performance of employees relative to others as well as relative to self. For example, the badge module awards badges based on relative performance of employees such as achieving number 1 rank, attaining a top position or a top quartile rank. Other type of badges include badges awarded when employees reach certain level of target (e.g., 80% of target, 100% of target, >100% of target). These types of badges recognize absolute performance of employees (and not riot relative performance). The method has multiple types of relative and absolute type badges which are configurable based on the rules of the organization. The method also includes providing rolling badges across cycles, where a cycle is a fixed time period of weeks, months, quarters or days. The logics in the rank and badge module are customizable as per the context of the organization.

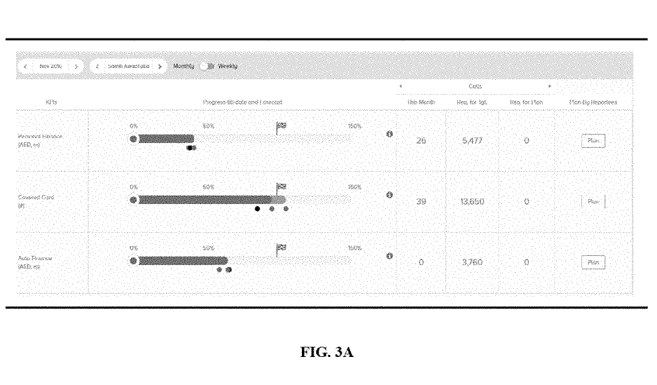

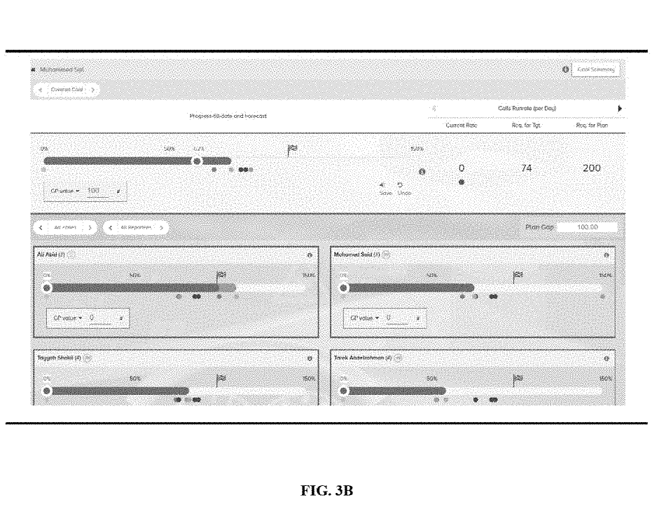

FIG. 3A illustrates screenshot 302 of a game-plan generated by a planning module 116. The employee sets personalized goals/sub-goals aligned to the targets set by the organization with the help of the planning module. The screenshot 302 illustrates a summary of the personalized goals/sub-goals set by an employee. The personalized goals/sub-goals include one or more of KPIs, attaining a rank, earning monthly incentive, attaining a status badge etc. The information about the progress till date and forecast of the related key performance indicators (KPI) is provided to the employee for planning the personalized goal/sub-goal. Further, the screenshot indicates the information provided on the activity “run rates”, i.e., the rate at which an employee is performing activities and rate required to achieve game-plan and target.

FIG. 3B illustrates screenshot 304 of a game-plan simulation performed through the planning module 116. The simulation of the game-plan allows the employee to understand and visualize the amount of input required to achieve an output. The levels of desired output are varied on the game-plan simulation and the planning engine suggests the amount of input required against the desired output. The simulation of game-plan also provides the information regarding the levels of output to be achieved for specific objectives such as qualifying monthly incentives to the employee. The method also provides actionable feedback for the employee about the input that he will have to put in order to achieve the desired objective. The screenshot also shows how a line manager simulates his personalized plan or allocates his personalized plan by reviewing the personalized plans of reportees. By simulating the reportees' game-plans, the line manager can visualize how much output Should be delivered by every reportee for the line manager to meet his personalized goals. Line managers and senior management also review the game-plans of their reportees and provide feedback on the aspiration levels and activity rates of the employee.

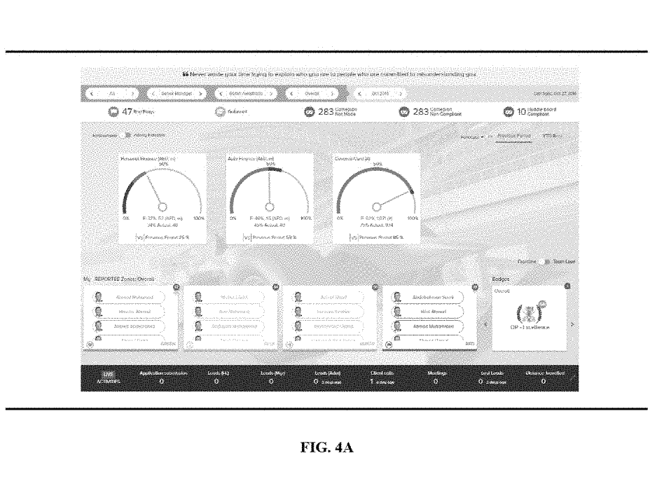

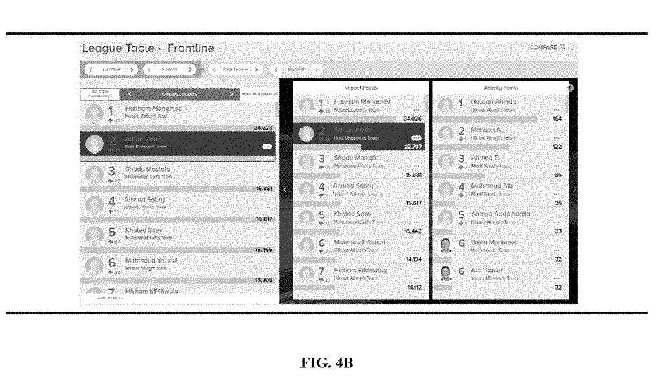

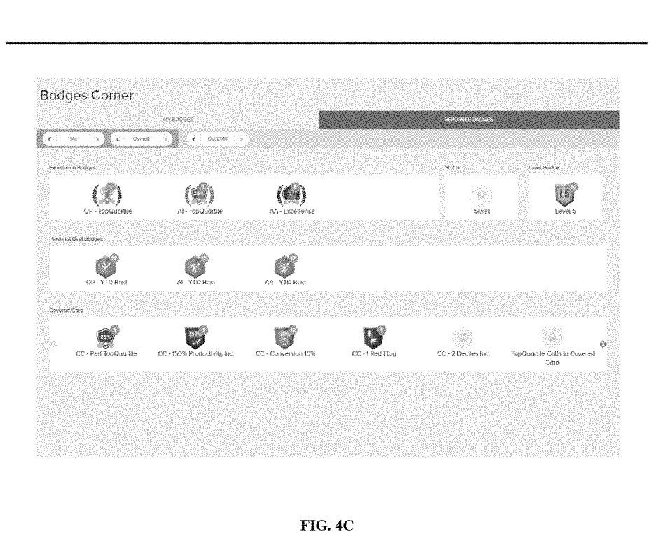

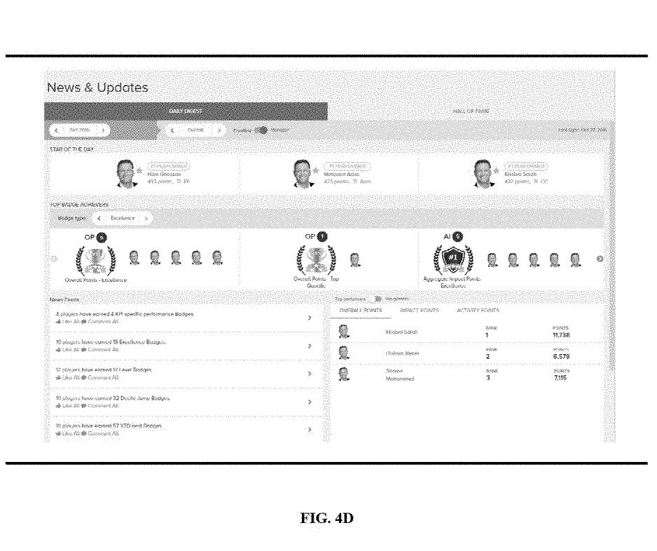

FIG. 4A illustrates a screenshot of the login screen of the application, according to one embodiment herein. The gamified performance management and the learning system 100 is run as an application on a user-equipment. The user equipment is one of a computer, a laptop, a mobile phone, a smartphone and a tablet. The first page of the application depicts a dashboard/“quick view” screen. The quick view screen includes the various details of an employee including the ranks, points and levels achieved by the employee during a particular cycle. The quick view screen further depicts the progress of the employee against the targets for different KPIs as well as provides the details on activities performed by the employee at KPI level. Furthermore, the quick view screen includes SWOT analysis of the employee. The SWOT analysis is a useful technique for understanding the strengths and weaknesses, and for identifying both, the opportunities open to the employee and the threat areas for the employee.

FIG. 4B illustrates a screenshot of the second page of the application depicting leaderboard for competition, according to one embodiment herein. The second page of the application depicts the leaderboard based on the points earned by the employee. The leaderboard is a scoreboard showing the names and overall points of all the peers of the employee in the decreasing order of their overall points. Leaderboard inspires the employees by showcasing the performance of the top performers. The method includes multiple leaderboards for overall points, impact points, and activity points and for individual. KPIs and activities, in order to allow the employee to evaluate the employee's performance across multiple dimensions of performance. The screenshot depicts three different types of the leaderboards.

Firstly, an overall points leaderboard indicates top performers scoring the highest total composite points along with the details of each performer. The details include the name of the employee, the points earned, the number of likes etc. Secondly, ail impact points leaderboard indicates top performers scoring the maximum impact points along with the details of each performer. The impact points are awarded based on the outputs achieved by the employee. Thirdly, an activity points leaderboard indicate top performers scoring the maximum activity points along with the points details of each performer. The activity points are awarded to the employees when the employee performs an action.

FIG. 4C illustrates a screenshot of the third page of application depicting badges, according to one embodiment herein. The, screenshot indicates badges awarded under different categories to the employee. Badges are awarded to the employees on achieving different objectives/interim objectives milestones, achieving best performance in the year, achieving number 1 rank or a rank top 10%, top 25% of all employees in any leaderboard, and for areas such as productivity improvement, activity to output conversion ratios (metrics where the performance of the employee is evaluated against his own figures and not in relation to other employees) etc. The method also provides rolling badges to the players across cycles.

FIG. 4D illustrates a screenshot of the fourth page of application depicting news and internal communication, according to one embodiment herein. The fourth page depicts the news and updates in the organization. The news includes the information of top performers in the company along with ranks achieved. Further, the news includes the teams performing high along with the ranks achieved. Further, the news includes details of the campaign winners in the organization. The screenshot of the fourth page further indicates the internal communication of the employees with the senior management and peers. The internal communication includes likes, comments, and appreciation received by the employee thereby serving to motivate employees socially.

The embodiments herein provide a system for motivating employees and driving performance through a combination of factors i) the invention offers the end-user (i.e., employees) the ability to create personalized goals through game-plans (thereby creating greater ownership on goals); ii) the invention drives performance and productivity through a dual focus on inputs as well as output measures. In contrast, classical performance management systems focus largely on outputs and do not always capture or manage around input measures in a systematic way. By influencing the inputs i.e., day-to-day actions and behaviors, the invention drives outputs by driving up inputs i.e., day-to-day activities of the employees; iii) the invention makes the enterprise performance management comprehensive by incorporating peer feedback, social metrics, and senior management feedback in a systematic way in the overall performance management system; iv) one of the key distinctions of the invention is that it offers, like an enterprise virtual assistant, system-driven ‘recommendations’ or suggestions to employees for improving their performance.

The system-driven ‘recommendations’ serve as a “virtual assistant cum guide” for employees, thereby driving performance improvement of employees v) the invention enables integration of knowledge levels (learning points) into the performance management system, thereby making the performance management system more holistic by bringing together input, output and knowledge levels under the same platform providing for valuable insights both for management and for employees. The system disclosed in the embodiments herein acts as a “motivation or behavior platform” designed with the belief that greater the employee motivation at the workplace the higher would be the performance and engagement levels. The system makes use of points, badges, ranks, challenges, feedback, social metrics, analytics, knowledge levels and various other tangible and intangible factors to motivate the employee. The power of the system lies in integrating the above said features in a single platform which collectively serve to drive up employee motivation and thus overall performance and engagement. Viewing this at the enterprise level, as the motivation levels of each and every employee under the system increases, the overall performance (i.e., employee productivity) and workplace engagement go up. Generally, the motivated employees are also engaged employees who have a sense of purpose and are driven towards higher goals and achievements.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications.

Although the embodiments herein are described with various specific embodiments, it will be obvious for a person skilled in the art to practice the embodiments herein with modifications.

What is claimed is:

1. A system for improving employee performance and engagement at workplace; the system comprises of:
an activity tracking/capturing module configured to track and capture a plurality of activities of an employee, wherein the plurality of activities include a plurality of input activities of the employee, and a plurality of its achieved by the employee, and wherein the action tracking module is communicably coupled with a performance management module;
a performance management module configured for evaluating and improving an employee's performance in an enterprise, wherein the performance management module includes:
a points module configured to convert the input activities to activity points (thereby enabling easy comparison of activity levels between various employees through the lens of points that serves as a common currency or metric for comparison), and the outputs achieved to impact points (thereby enabling easy comparison of results achieved between various employees through the lens of points) wherein the input activities and the outputs achieved are converted respectively into the activity points and the impact points based on the employee activities and results determined or identified or tracked by the action tracking module, and wherein the points module is configured to employ or utilize a customizable logic for converting the input activity and the output results respectively into the activity points and the impact points, and wherein the points are awarded to the employee in near real-time;
a rank and badge module configured to award a plurality of ranks, badges, status, levels, and nudges/social mentions (“like”, “follow”, “comment”) to the employee, and wherein the rank and badge module is configured to determine a rank, a badge, a status, a level and leaderboard mention (social mention i.e., ‘like’ or ‘follow’ or ‘comment’) to the employee based on the points earned through the points module, and wherein the rank and badge module is communicably coupled to the points module;
a communication module configured to establish a wired/wireless communication primarily for the purposes of broadcasting achievements of a plurality of employees (e.g., broadcasting award of badges, announcement of top players in the leaderboard and top gainers who climbed maximum ranking). In addition, the communication module enables interactions between employees and a plurality of hierarchy levels, and wherein the communication module is configured to enable the employee to communicate through a digital medium;
a planning module configured to enable a plurality of employees set personalized goals (“game-plan”) and simulate the level of activities required to achieve their respective personalized goals, wherein the planning module is configured to allow each employee to create and follow a personalized goal or game-plan that is guided by a targets set by the enterprise, wherein the personalized goals or game-plan set by the employee is guided by the target set by the enterprise yet the game-plan is distinct from the targets in the sense that it represents the employee's own “output aspirations”; wherein the “game-plan” can be simulated around various output aspirations objectives (e.g., earning a certain quantum of incentives, winning a badge, say the top employee badge), wherein the planning module enables line managers to provide feedback in a digital manner on the game-plans set by their direct reportees and wherein the planning module allows, line managers to simulate and cascade/allocate their personal plans to their direct reportees (in other words, a line manager gets to simulate the levels of output that need to be achieved by his direct reportees in order for the line manager to achieve his personalized goal. The simulation also makes transparent the level of inputs required by each employee in order for the line manager to achieve his personalized goal or game-plan);
a recommendation module configured to provide suggestions/recommendations to the employee on a plurality of dimensions, and wherein the recommendation module is configured to provide suggestions/recommendations based on predictive analytics/analyses and rules set by the enterprise or algorithms built into the digital system, wherein the recommendations presented by the recommendation module to the employee are designed to inform the employee of the proximate opportunities and/or requirements to reach a personalized goal or earn a badge (e.g., through notifications such as “you are 500 points away from achieving your game-plan and earning the top-quartile performance badge” or “you need to increase the rate of a specific activity in order to achieve your game-plan this week”), wherein the recommendations are designed to drive the employee into action and aspire for higher levels of performance, wherein the recommendations are provided to drive an employee to action by serving as a trigger for the employee to set an aspirational personalized goal through the planning module and wherein the recommendation module is communicably coupled to the planning module;
a campaign builder module configured to create and run a plurality of seasonal campaigns for employees, and wherein the plurality of seasonal campaigns are created and run to motivate the employee to aim and achieve higher levels of outputs and productivity than that achieved during a regular period i.e., under a “business-as-usual” scenario, and wherein the productivity achieved by the employees during the seasonal campaign is more than the productivity achieved by employees during a regular period, and wherein the campaign module is communicably coupled to the communication module;
a challenge module configured to challenge the employee to achieve or exceed a desired output set by a challenger, and wherein the challenge module is configured to identify a super performer, an over performer, an average performer, and an underperformer, based on analytics and a set of rules, and wherein the challenge module is communicably coupled to the communication module. Challenge is primarily focused towards the average performers and under performers. The challenger (typically a system administrator/direct line manager) throws a “challenge” to the target employee. Such target employees are identified based on analytics. The challenge is communicated digitally and serves to stimulate the employee to clear the challenge and thus achieve higher performance in the process. The challenge module is complimentary to the campaign module in the sense that the campaign module targets a large audience or set of employees and in contrast, the challenge module specifically targets the average/under performers with specific and time bound goals/challenges to meet;
a redemption module configured to redeem the activity points and the impact points accrued by the employee for a tangible and/or intangible reward;
an analytics module configured to provide a quantitative view of the performance of a plurality of employees, wherein the analytics module is configured to generate a comprehensive performance dashboard, and wherein the performance dashboard is configured to cover the performance over a plurality of parameters, and wherein the analytics module is configured to generate insights and reports based on the predictive analyses and rules, and wherein the analytics module is communicably coupled to all other modules; and
a learning games module configured to organize a plurality of learning modules, and wherein the learning module is configured to impart/improve knowledge and skills of a plurality of employees for performing tasks in the enterprise more accurately, effectively and efficiently, wherein the games module is communicably coupled with the performance management module.

2. The system according to claim 1, wherein the action tracking module is configured to track the input activities performed by the employee of the enterprise, and wherein the input activities include (but are not limited to) submitting a client call report, creating a business lead, following-up on business leads, meeting a customer/client, submitting a business proposal, submitting a business idea, completing internal project milestones, completing internal processes and completing a learning module. Additionally, input activities could include input factors such as employee attendance, referrals made by the employee to other employees, amount of time spent by the employee at the workplace, number of core processes initiated by the employee or completed by the employee (processes for which the employee is responsible for).

3. The system according to claim 1, wherein the action tracking module is configured to track the outputs achieved by the employees of the enterprise against their respective targets (as measured through KPIs) set for the employees by the senior management. Such achievements could include (but, are not limited to) the closure of a sale, completion of a process project, launch of a product, achieving revenue/profit/cost targets etc.; and wherein the action tracking module is configured to provide feedback to the employee and to the performance management module.

4. The system according to claim 1, wherein the planning module is configured to allow each employee to create and follow a personalized goal or game-plan that is guided by a targets set by the enterprise, wherein the personalized goals or game-plan set by the employee is guided by the targets set by the enterprise for the employee but importantly the personalized goal or game-plan represents the employee's own “output aspirations”, wherein the “game-plan” can be simulated around various objectives (e.g., earring a certain quantum of incentives, winning, a badge, say the top employee badge), wherein the planning module enables line managers to provide feedback in a digital manner on the game-plans set by their direct reportees and wherein the planning module allows line managers to simulate and cascade/allocate their personal plans to their direct reportees (in other words, a line manager gets to s Mate the levels of output that need to be achieved by his direct reportees it order for the line manager to achieve his personalized goal. The simulation also makes transparent the level of inputs required by each employee in order for the line manager to achieve his personalized goal or game-plan);

5. The system according to claim 1, wherein the recommendation module is configured to generate the recommendations based on past performance track record of the employee, wherein recommendation module is configured to provide suggestions/recommendations to the employee on a plurality of dimensions, and wherein the recommendation module is configured to provide suggestions/recommendations based on predictive analytics/analyses and rules set by the enterprise or algorithms built into the digital system, wherein the recommendations presented by the recommendation module to the employee are designed to inform the employee of the proximate opportunities and: or requirements to achieve a goal or earn a badge (e.g., through notifications such as “you are 500 points away from achieving your game-plan and earning the top-quartile performance badge” or “you need to increase the rate of a specific activity in order to achieve your game-plan this week”), wherein the recommendations are designed to drive the employee into action and aspire for higher levels of performance and wherein the recommendations are provided to drive an employee to action by serving as a trigger for the employee to set an aspirational personalized goal through the planning module.

6. The system according to claim 1, wherein the parameters used for analyses include performance against targets (measured through achievement against Key Performance Indicators—KPIs), activity levels, knowledge/skill levels, and performance trends and correlations across different parameters.

7. The system according to claim 1 further comprises a database configured to store data and metadata about the action tracking module, performance management module, and learning games module.

8. A computer implemented method comprising instructions stored on a non-transitory computer-readable storage medium and executed on a computing device comprising a hardware processor and a memory for improving an employee performance and engagement at a workplace, the method comprises:
tracking a plurality of activities performed by a plurality of employees and plurality of outputs achieved by a plurality of employees through an action tracking module, and wherein the plurality of activities includes a plurality of input activities of the employee, and a plurality of outputs include results achieved by the employee;
evaluating, managing and improving an employee performance in an enterprise through a performance management module, wherein the step of evaluating managing and improving the performance of the plurality of employees comprises:
converting the input activities to activity points and converting the outputs achieved to impact points through a points module, wherein the input activity and the output activity are converted respectively into the activity points and the impact points based on the employee activity and employee output determined or identified or tracked by the action tracking module, and wherein a customizable logic is employed or utilized for converting the input activity and the output activity respectively into the activity points and the impact points, and wherein the points are awarded to the employee in near real-time;
awarding a plurality of ranks, badges, awards, levels and leaderboard mention to the employee through the rank and badge module, and wherein a rank, a badge, an award, a level and leaderboard mention awarded to the employee is determined by the rank and badge module based on the points provided by the points module;
establishing a wired/wireless communication between a plurality of hierarchy levels, through a communication module to enable the employee to communicate through a digital medium;
enabling a plurality of employees (through a planning module) to create/set personalized goals (“game-plan”) and simulate the game-plan to understand the level of activities required to achieve the personalized goal, wherein the method allows each employee to create and follow a personalized goal or game-plan that is guided by a targets set by the enterprise, wherein the personalized goals or game-plan set by the employee is guided by the target set by the enterprise yet the personalized goal or game-plan is distinct from the targets in the sense that it represents the employee's own “output aspirations”, wherein the “game-plan” can be simulated around various output aspiration/objectives (e.g., earning a certain quantum of incentives, winning a badge, say the top employee badge), wherein the line managers can provide feedback to their direct reportees (through the planning module in a digital manner) on the game-plans set by their direct reportees and wherein the line managers can simulate and cascade/allocate their personal plans to their direct reportees (in other words, a line manager can simulate the levels of output that need to be achieved by his direct reportees in order for the line manager to achieve his own personalized goal. The simulation also makes transparent the level of inputs required by each employee in order for the line manager to achieve his personalized goal or game-plan;
providing tailored suggestions/recommendations to a plurality of employees on a plurality of dimensions through a recommendation module based on predictive analytics/analyses and rules set by the enterprise or algorithms, wherein the recommendations presented by the recommendation module to the employee are designed to inform the employee of the proximate opportunities and/or requirements to achieve a goal or earn a badge (e.g., through notifications such as “you are 500 points away from achieving your game-plan and earning the top-quartile performance badge” or “you need to increase the rate of a specific activity in order to achieve your game-plan this week”), wherein the recommendations are designed to drive the employee into action and aspire for higher levels of performance, wherein the recommendations drive the employee to action by serving as a to trigger for the employee to set personalized goals through the planning module;
creating and running a plurality of seasonal campaigns for the employee through a campaign builder module, and wherein the plurality of seasonal campaigns is created and run to motivate the employee to aim and achieve higher levels of productivity, and wherein the productivity achieved by the employee during the seasonal campaign is more than the productivity achieved by the employee during a regular period;
throwing performance challenge through the challenge module to a plurality of employees to achieve or exceed a desired level of output as set in the challenge. The challenge is primarily focused towards the average performers and under performers among the employees. Primarily, system/system administrator/direct line manager can set and throw a “challenge” to a target employee. The challenge is communicated digitally through the challenge module and serves to stimulate the average performers/under performers to achieve higher performance through the acceptance of the challenge. The challenge method is complimentary to the campaign method in the sense that a campaign targets a large audience or set f employees and in contrast, a challenge specifically targets the average/under performers with specific and time bound goals/targets to meet;
redeeming the activity points and the impact points accrued by the employee into a tangible and/or intangible reward through a redemption module;
analyzing the performance of the employee through an analytics module to provide a quantitative view of the performance of the employee, wherein a comprehensive performance dashboard is generated through the analytics module, and wherein the performance dashboard is configured to cover the performance over a plurality of parameters, and wherein insights and reports are generated by the analytics module based on the predictive analysis and rules; and
offering a plurality of learning modules to a plurality of employees by creating a plurality of learning games through a games module, and wherein the learning modules are generated using the learning games to impart knowledge and skills to a plurality of employees for performing tasks in the enterprise more accurately, effectively and efficiently, and wherein the games are organized based on the analyses performed by the performance management module.

9. The method according to claim 8, wherein the input activities include (but are not limited to) submitting a client call report, creating a business lead, following-up on business leads, meeting a customer, submitting a business proposal, submitting a business idea, completing internal project milestones and completing a learning module. Additionally, input activities could include input factors such as employee attendance, referrals made by the employee to other employees, amount of time spent by the employee at the workplace, number of core processes initiated by the employee or completed by the employee (processes for which the employee is responsible for).

10. The method according to claim 8, wherein the outputs achieved by the employees of the enterprise are measured as achievement against targets (e.g., achievement against targets measured through KPIs set for the employees by the management). Such achievements could include (but are not limited to) the closure of a sale, completion of a process/project, launch of a product, achieving revenue/profit/cost targets etc.; and wherein the outputs of the employee are tracked by the action tracking module to provide a feedback to the employee and to the performance management module.

11. The method according to claim 8, wherein the game-plans are created through the planning module to allow each employee to create and follow a personalized goal or game-plan that is guided by a targets set by the enterprise, wherein the personalized goals or game-plan set by the employee is guided by the target set by the enterprise yet the personalized goal or game-plan is distinct from the targets in the sense that it represents the employee's own “output aspirations”, wherein the “game-plan” can be simulated around various output aspiration/objectives (e.g., earning a certain quantum of incentives, winning a badge, say the top employee badge), wherein the line managers can provide feedback to their direct reportees (through the planning module in a digital manner) on the game-plans set by their direct reportees and wherein the line managers can simulate and cascade/allocate their personal plans to their direct reportees (in other words, a line manager can simulate the levels of output that need to be achieved by his direct reportees in order for the line manager to achieve his own personalized goal. The simulation also makes transparent the level of inputs required by each employee in order for the line manager to achieve his personalized goal or game-plan);

12. The method according to claim 8, wherein tailored suggestions/recommendations are provided through a recommendation module to a plurality of employees on a plurality of dimensions through a recommendation module based on predictive analytics analyses and rules set by the enterprise or algorithms, wherein the recommendations presented by the recommendation module to the employee are designed to inform the employee of the proximate opportunities and/or requirements to achieve a goal or earn a badge (e.g., through notifications such as “you are 500 points away from achieving your game-plan and earning the top-quartile performance badge” or “you need to increase the rate of a specific activity in order to achieve your game-plan this week”), wherein the recommendations are designed to drive the employee into action and aspire for higher levels of performance, wherein the recommendations drive the employee to action by serving as a trigger for the employee to set personalized goals through the planning module;

13. The method according to claim 8, wherein the parameters used for analyses include performance against targets (measured through achievement against Key Performance Indicators—KPIs), activity levels, knowledge/skill levels, and performance trends and correlations across different parameters.

14. The method according to claim 8, wherein the method further includes storing data and metal to about the activities tracked, management of performance, and designing and offering digital learning games.
